(19) United States
(12) Patent Application Publication
(10) Pub. No.: US 2021/0153223 A1
(43) Pub. Date: May 20, 2021

(54) TRANSMITTING AND RECEIVING INDIVIDUAL SUBBANDS

(71) Applicant: QUALCOMM Incorporated, San Diego, CA (US)

(72) Inventors: Mayank Batra, Cambridge (GB); Magnus Sigverth Sommansson, Veberod (SE); Laurence George Richardson, Ely (GB); Jonathan Grenville Tanner, Sidmouth (GB); Christopher Church, Cambridge (GB)

(21) Appl. No.: 16/684,530

(22) Filed: Nov. 14, 2019

(51) Int. Cl. H04W 72/12; H04W 72/04

(52) U.S. Cl. CPC H04W 72/1242; H04W 72/0453; H04W 72/1231

(57) ABSTRACT

Methods, systems, and devices for wireless communications are described. A device may break down (e.g., filter) a frequency band of an input signal into various subbands, and an encoding stage may then allocate bits across the various subbands. In some examples, the encoding stage may allocate proportionally more bits to higher prioritized (e.g., lower frequency) subbands. Once the subbands have been encoded, the output of each individual encoder (e.g., each encoded subband) may be transmitted in a packet. As such, subbands transmitted as single packets (e.g., subbands transmitted in individual packets) may be shorter in length and may be more efficiently prioritized by a transmitter and a receiver. For example, subbands may be prioritized based on a location where the most data is found in audio, based on the tone of a speaker (e.g., for speech encoding), etc.

### BACKGROUND

The following relates generally to wireless communications, and more specifically to transmitting and receiving individual subbands.

Wireless communications systems are widely deployed to provide various types of communication content such as voice, video, packet data, messaging, broadcast, and so on. These systems may be multiple-access systems capable of supporting communication with multiple users by sharing the available system resources (e.g., time, frequency, and power). A wireless network, for example a wireless local area network (WLAN), such as a Wi-Fi (i.e., Institute of Electrical and Electronics Engineers (IEEE) 802.11) network may include an access point (AP) that may communicate with one or more wireless or mobile devices. The AP may be coupled to a network, such as the Internet, and may enable a mobile device to communicate via the network (or communicate with other devices coupled to the access point).

A wireless device may communicate with a network device bi-directionally. For example, in a WLAN, a device may communicate with an associated AP via downlink (e.g., the communication link from the AP to the device) and uplink (e.g., the communication link from the device to the AP). A wireless personal area network (PAN), which may include a Bluetooth connection, may provide for short range wireless connections between two or more paired wireless devices. For example, wireless devices such as cellular phones may utilize wireless PAN communications to exchange information such as audio signals with wireless headsets.

### SUMMARY

The described techniques relate to improved methods, systems, devices, or apparatuses that support transmitting and receiving individual subbands. Generally, the described techniques provide for filtering of an input signal into subbands and for communication of the subbands via individual packets.

In some examples, wireless communications may benefit from improved quality of service. For example, successful bidirectional transmission of audio information for voice information may have a relatively low tolerance for packet loss or timing issues. The link quality between two devices may affect the data rate used for communications (e.g., as poor link quality may be associated with reduced bitrates for more robust communications).

In some examples, a device may break down an input signal (e.g., which may be speech or music) into a number of subbands (e.g., 4 subbands) via a series of Low and High Pass Filters, Decimators, and Encoders. The frequency band of the input signal may thus be broken down into the various subbands, and an encoding stage may then allocate bits across the various subbands. In some examples, the encoding stage may allocate proportionally more bits to higher prioritized (e.g., lower frequency) subbands. Once the subbands have been encoded, the output of each individual encoder (e.g., each encoded subband) may be transmitted in a packet.

As such, subbands transmitted as single packets (e.g., subbands transmitted in individual packets) may be shorter in length and may be more efficiently prioritized by a transmitter and a receiver. For example, subbands may be prioritized based on a location where the most data is found in audio, based on the tone of a speaker (e.g., for speech encoding), etc. By prioritizing subband packets (e.g., and communicating filtered subbands in individual packets), the most important information may be retransmitted more often when link quality is poor (e.g., rather than retransmitting all encoded subbands as a single packet). In some examples, speech may also be analyzed to dynamically select which subbands are the highest priority.

A method of communication at a wireless device is described. The method may include encoding a set of subbands corresponding to an input signal into a set of packets, each packet of the set of packets including encoded data corresponding to a single respective subband. The method may further include determining that a first priority of a first subband encoded in a first packet of the set of packets is different than a second priority of a second subband encoded in a second packet of the set of packets, determining a link condition that includes a link quality condition, a type of traffic associated with the link, or both, and transmitting the first packet in a first transmission occasion based on the determined link condition and the determination that the first priority is different than the second priority.

An apparatus for communication at a wireless device is described. The apparatus may include a processor, memory coupled with the processor, and instructions stored in the memory. The instructions may be executable by the processor to cause the apparatus to encode a set of subbands corresponding to an input signal into a set of packets, each packet of the set of packets including encoded data corresponding to a single respective subband, determine that a first priority of a first subband encoded in a first packet of the set of packets is different than a second priority of a second subband encoded in a second packet of the set of packets, determine a link condition that includes a link quality condition, a type of traffic associated with the link, or both, and transmit the first packet in a first transmission occasion based on the determined link condition and the determination that the first priority is different than the second priority.

Another apparatus for communication at a wireless device is described. The apparatus may include means for encoding a set of subbands corresponding to an input signal into a set of packets, each packet of the set of packets including encoded data corresponding to a single respective subband, determining that a first priority of a first subband encoded in a first packet of the set of packets is different than a second priority of a second subband encoded in a second packet of the set of packets, determining a link condition that includes a link quality condition, a type of traffic associated with the link, or both, and transmitting the first packet in a first transmission occasion based on the determined link condition and the determination that the first priority is different than the second priority.

A non-transitory computer-readable medium storing code for communication at a wireless device is described. The code may include instructions executable by a processor to encode a set of subbands corresponding to an input signal into a set of packets, each packet of the set of packets including encoded data corresponding to a single respective subband, determine that a first priority of a first subband encoded in a first packet of the set of packets is different than a second priority of a second subband encoded in a second packet of the set of packets, determine a link condition that includes a link quality condition, a type of traffic associated with the link, or both, and transmit the first packet in a first transmission occasion based on the determined link condition and the determination that the first priority is different than the second priority.

Some examples of the method, apparatuses, and non-transitory computer-readable medium described herein may further include operations, features, means, or instructions for transmitting the second packet in a second transmission occasion based on the determined link condition and the determination that the first priority may be different than the second priority, where the first transmission occasion precedes the second transmission occasion. Some examples of the method, apparatuses, and non-transitory computer-readable medium described herein may further include operations, features, means, or instructions for identifying a retransmission opportunity associated with the first packet, and retransmitting the first packet based on the retransmission opportunity, where the first packet may be associated with more retransmission opportunities than the second packet.

In some examples of the method, apparatuses, and non-transitory computer-readable medium described herein, determining the link condition may include operations, features, means, or instructions for determining the link quality condition may be below a threshold, where the retransmission opportunity associated with the first packet may be identified based on the determination that the link quality condition may be below the threshold. In some examples of the method, apparatuses, and non-transitory computer-readable medium described herein, the first transmission occasion, a first periodicity associated with the first transmission occasion, a first number of retransmission opportunities associated with the first packet, or some combination thereof may be based on the first priority, and where the second transmission occasion, a second periodicity associated with the second transmission occasion, a second number of transmission opportunities associated with the second packet, or some combination thereof may be based on the second priority.

Some examples of the method, apparatuses, and non-transitory computer-readable medium described herein may further include operations, features, means, or instructions for transmitting an indication of the first transmission occasion, the second transmission occasion, the first periodicity, the second periodicity, the first number of retransmission opportunities, the second number of retransmission opportunities, or some combination thereof, where the first packet may be transmitted based on the transmitted indication. Some examples of the method, apparatuses, and non-transitory computer-readable medium described herein may further include operations, features, means, or instructions for identifying a frequency range priority of one or more frequency ranges of the input signal, where the determination that the first priority of the first subband encoded in the first packet may be different than the second priority of the second subband encoded in the second packet may be based on the identified frequency range priority.

Some examples of the method, apparatuses, and non-transitory computer-readable medium described herein may further include operations, features, means, or instructions for receiving an indication of a first frequency range, where the frequency range priority may be identified based on the received indication. In some examples of the method, apparatuses, and non-transitory computer-readable medium described herein, the frequency range priority may be identified based on the frequency location of the audio data in the input signal. Some examples of the method, apparatuses, and non-transitory computer-readable medium described herein may further include operations, features, means, or instructions for filtering the input signal to generate the set of subbands based on the identified frequency range priority of the one or more frequency ranges, where the set of subbands may be encoded based on the filtering.

A method of communication at a wireless device is described. The method may include determining that a first priority of a first subband is higher than a second priority of a second subband and receiving one or more packets corresponding to a set of subbands, where each packet of the one or more packets includes encoded data corresponding to a single respective subband. The method may further include decoding a first packet corresponding to the first subband having the higher priority based on the determination that the first priority is higher than the second priority.

An apparatus for communication at a wireless device is described. The apparatus may include a processor, memory coupled with the processor, and instructions stored in the memory. The instructions may be executable by the processor to cause the apparatus to determine that a first priority of a first subband is higher than a second priority of a second subband, receive one or more packets corresponding to a set of subbands, where each packet of the one or more packets includes encoded data corresponding to a single respective subband, and decode a first packet corresponding to the first subband having the higher priority based on the determination that the first priority is higher than the second priority.

Another apparatus for communication at a wireless device is described. The apparatus may include means for determining that a first priority of a first subband is higher than a second priority of a second subband, receiving one or more packets corresponding to a set of subbands, where each packet of the one or more packets includes encoded data corresponding to a single respective subband, and decoding a first packet corresponding to the first subband having the higher priority based on the determination that the first priority is higher than the second priority.

A non-transitory computer-readable medium storing code for communication at a wireless device is described. The code may include instructions executable by a processor to determine that a first priority of a first subband is higher than a second priority of a second subband, receive one or more packets corresponding to a set of subbands, where each packet of the one or more packets includes encoded data corresponding to a single respective subband, and decode a first packet corresponding to the first subband having the higher priority based on the determination that the first priority is higher than the second priority.

Some examples of the method, apparatuses, and non-transitory computer-readable medium described herein may further include operations, features, means, or instructions for transmitting an indication of the first priority of the first subband, where the one or more packets may be received based on the transmitted indication.

In some examples of the method, apparatuses, and non-transitory computer-readable medium described herein, the first packet may be received in a first transmission occasion preceding a second transmission occasion associated with a second packet of the one or more packets and the first packet may be associated with more retransmission opportunities than the second packet.

### BRIEF DESCRIPTION OF THE DRAWINGS

FIG. 1 illustrates an example of a system for wireless communications that supports transmitting and receiving individual subbands in accordance with aspects of the present disclosure.

FIG. 2 illustrates an example of a wireless communications system that supports transmitting and receiving individual subbands in accordance with aspects of the present disclosure.

FIG. 3 illustrates an example of a signal processing diagram that supports transmitting and receiving individual subbands in accordance with aspects of the present disclosure.

FIGS. 4 and 5 show block diagrams of devices that support transmitting and receiving individual subbands in accordance with aspects of the present disclosure.

FIG. 6 shows a block diagram of a communications manager that supports transmitting and receiving individual subbands in accordance with aspects of the present disclosure.

FIG. 7 shows a diagram of a system including a device that supports transmitting and receiving individual subbands in accordance with aspects of the present disclosure.

FIGS. 8 and 9 show flowcharts illustrating methods that support transmitting and receiving individual subbands in accordance with aspects of the present disclosure.

### DETAILED DESCRIPTION

In some wireless communications systems, communicating devices (e.g., Bluetooth devices) may employ a codec (e.g., hardware, software, etc.) for encoding or decoding a digital data stream or a signal. In some examples, a codec may be referred to as a coder-decoder, where the codec may be used to encode a data stream or signal for transmission or storage and decodes (e.g., reverses the encoding) for playback or editing (e.g., for receiving a data stream or signal). Different codecs (e.g., encoder modes, decoder modes, codec configurations, etc.) may be employed for different applications (e.g., such as gaming, voice, etc.). For example, a Subband Codec (SBC) may break down an input signal (e.g., voice, music, etc.) into a number of subbands (e.g., one to four subbands) via a series of filters, decimators, and encoders. For example, a transmitting device employing SBC may process an input signal using a series of low and high pass filters or band-pass filters that separate information across the frequency band of the input signal into a number of subbands. The device may then encode the subbands at an encoder by allocating a number of bits to each subband. After encoding the filtered subbands of the signal, the device may group the encoded subbands (e.g., the encoded subbands may be multiplexed) into a single long packet and the device may transmit the single long packet over the air (e.g., to a receiving device for playback).

However, some wireless communications (e.g., such as bidirectional transmission of audio information for voice, Bluetooth high definition (HD) communications, etc.) may have a relatively low tolerance for packet loss or timing issues. In such systems, encoding filtered subbands of a signal into a single long packet may result in retransmission of the entire signal in cases of unsuccessful transmission. For example, poor link conditions, affected by noise, distance, interference, etc., may be associated with increased occurrence of information loss (e.g., packet loss) during wireless communications. Due to their length, long packets may be prone to disruption when link conditions are poor. In cases where link conditions are poor, communication via long packets may result in retransmission failures, retransmission latency, and degraded user experience. Additionally, in cases where link conditions are poor, long packets may be disrupted and a transmitting device may need to retransmit the entire packet again. Likewise, a receiving device may need to provide another reception opportunity for the entire packet. This may lead to undesirable power and time costs.

According to the techniques described herein, filtered subbands may be encoded and transmitted in a number of packets. In some examples, the number of subbands may equal the number of packets (e.g., there may be a 1:1 relationship between the number of subbands and the number of packets). For example, each subband of the number of subbands associated with the input signal (e.g., each filtered subband of an input signal) may be transmitted in its own packet. As such, the packets (e.g., each packet for each individual subband) may be shorter in length and less susceptible to poor link conditions. Additionally, such subband based packet transmission may provide for more efficient packet prioritization by a transmitting device and a receiving device. For example, a transmitting device and a receiving device may determine to provide more transmission and reception opportunities for a packet that includes more valuable information to the receiver (e.g., to the user) than a packet that includes less valuable information.

In some examples, a wireless communications system (e.g., a transmitting device and a receiving device) may prioritize a packet based on the subband (e.g., filtered frequency region) of the input signal associated with the packet. For example, a transmitting device and a receiving device may prioritize a subband based on the information (e.g., the priority of the information) corresponding to (e.g., filtered into) the subband. The priority of the information in a subband may correspond to a frequency location of the signal where the highest priority information is found (e.g., a subband or frequency location where the most information of the signal is found or where the most relevant information for a user is found). In some examples, the frequency location of the signal where the highest priority information is found may depend on a tone of a speaker, a type of input signal, a receiver (e.g., user) preference, a link condition, etc. In some examples, the priority of information conveyed via various subbands may be previously known (e.g., configured) by a transmitting device or a receiving device (or both) or the priority of information conveyed via various subbands may be determined by a transmitting device or a receiving device (or both) based on an analysis of a signal.

In some examples, the priority of a packet may be preset between two communicating devices (e.g., subband priority, and thus packet priority, may be set by a codec, configured by a communications system, etc.). For example, the human ear may be more sensitive to lower end frequencies, such that, in some examples, a number of packets conveying the lower frequency range of the audible frequency band may be prioritized higher than a number of packets conveying the higher frequency range. A transmitting device and a receiving device may then prioritize (e.g., provide more retransmission opportunities for) the number of packets conveying the lower frequency range over the number of packets conveying the higher frequency range.

In some examples, the priority of a packet may be determined based on an analysis of the input signal (e.g., the signal to be transmitted to a receiving device). For example, a transmitting device and a receiving device may prioritize a number of packets based on an analysis of the signal that determines the frequency ranges that include the highest priority information. Additionally or alternatively, the communicating devices may dynamically prioritize packets based on a determined link condition. For example, a packet (e.g., a low priority packet) may be deprioritized to a lower prioritization level (e.g., when link conditions are poor) and may subsequently be prioritized to a higher prioritization level (e.g., when link conditions improve). In other words, packets corresponding to information (e.g., subbands) of lesser priority may be less frequently transmission (e.g., or dropped entirely) when link conditions are poor (e.g., which may provide for more retransmission opportunities for packets corresponding to information (e.g., subbands) of higher priority.

In some aspects of the present disclosure, communicating devices may determine to provide more opportunities (e.g., transmission, opportunities, reception opportunities, retransmission opportunities, etc.) to higher priority packets than lower priority packets. As such, by transmitting a signal in a number of individual packets prioritized based on the priority of the information (e.g., subband) conveyed by the respective packets, the most important information may have a greater chance for successful reception based on more transmission or reception (or both) opportunities. Additionally, transmitting a signal in individual subband based packets may enable communicating devices to have more flexibility in the number of transmission and reception opportunities that may be provided for each individual subband based packet. For example, a receiving device (e.g., a receiving device in a power saving mode) may only provide reception opportunities to a subset of the number of packets (e.g., packets associated with higher priority subbands) and may not provide any reception opportunities for a different subset of the number of packets (e.g., packets associated with lower priority subbands). As such, higher priority information may be more communicated more robustly and successfully under poor link conditions resulting in improved communications (e.g., for low latency applications, for reliable communication applications, etc.).

Aspects of the disclosure are initially described in the context of wireless communications systems. Aspects of the disclosure are then described with reference to an example signal processing diagram. Aspects of the disclosure are further illustrated by and described with reference to apparatus diagrams, system diagrams, and flowcharts that relate to transmitting and receiving individual subbands

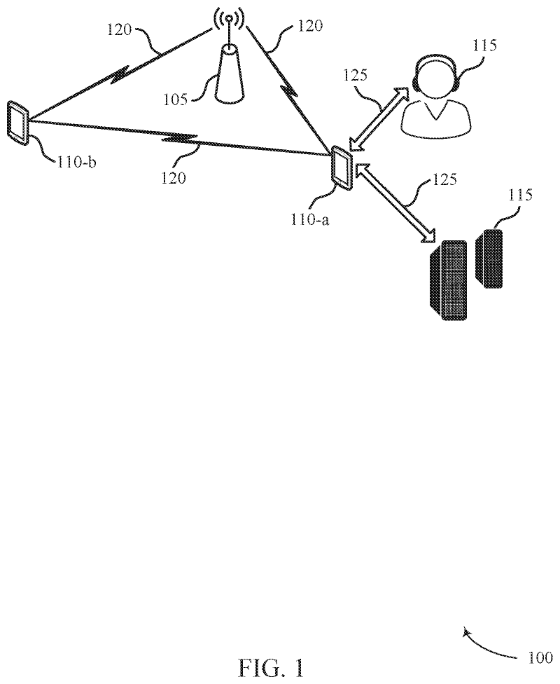

FIG. 1 illustrates an example of a wireless communications system 100 that supports transmitting and receiving individual subbands in accordance with aspects of the present disclosure. In some examples, the wireless communications system 100 may include or refer to a wireless personal area network (PAN), a wireless local area network (WLAN), a Wi-Fi network) configured in accordance with various aspects of the present disclosure. The wireless communications system 100 may include an access point (AP) 105, devices 110 (e.g., which may be referred to as source devices, master devices, etc.), and paired devices 115 (e.g., which may be referred to as sink devices, slave devices, etc.) implementing WLAN communications (e.g., Wi-Fi communications) or Bluetooth communications (or both). For example, devices 110 may include cell phones, user equipment (UEs), wireless stations (STAs), mobile stations, personal digital assistant (PDAs), other handheld devices, netbooks, notebook computers, tablet computers, laptops, or some other suitable terminology. Paired devices 115 may include Bluetooth-enabled devices capable of pairing with other Bluetooth-enabled devices (e.g., such as devices 110), which may include wireless audio devices (e.g., headsets, earbuds, speakers, car pieces, headphones), display devices (e.g., TVs, computer monitors), microphones, meters, valves, etc.

Bluetooth communications may refer to a short-range communication protocol and may be used to connect and exchange information between devices 110 and paired devices 115 (e.g., between mobile phones, computers, digital cameras, wireless headsets, speakers, keyboards, mice or other input peripherals, and similar devices). Bluetooth systems (e.g., aspects of wireless communications system 100) may be organized using a master-slave relationship employing a time-division duplex protocol having, for example, defined time slots of 625 mu seconds, in which transmission alternates between the master device (e.g., a device 110) and one or more slave devices (e.g., paired devices 115). In some examples, a device 110 may generally refer to a master device, and a paired device 115 may refer to a slave device in the wireless communications system 100. As such, in some examples, a device may be referred to as either a device 110 or a paired device 115 based on the Bluetooth role configuration of the device. That is, designation of a device as either a device 110 or a paired device 115 may not necessarily indicate a distinction in device capability, but rather may refer to or indicate roles held by the device in the wireless communications system 100. Generally, device 110 may refer to a wireless communications device capable of wirelessly exchanging data signals with another device (e.g., a paired device 115), and paired device 115 may refer to a device operating in a slave role, or to a short-range wireless communications device capable of exchanging data signals with the device 110 (e.g., using Bluetooth communication protocols).

A Bluetooth-enabled device may be compatible with Bluetooth profiles to use desired services. A Bluetooth profile may refer to a specification regarding an aspect of Bluetooth-based wireless communications between devices. That is, a profile specification may refer to a set of instructions for using the Bluetooth protocol stack in a specific way, and may include information such as suggested user interface formats, particular options and parameters at each layer of the Bluetooth protocol stack, etc. For example, a Bluetooth specification may include various profiles that define the behavior associated with each communication endpoint to implement a specific use case. Profiles may thus generally be defined according to a protocol stack that promotes and allows interoperability between endpoint devices from different manufacturers through enabling applications to discover and use services that other nearby Bluetooth-enabled devices may be offering. The Bluetooth specification defines device role pairs (e.g., roles for a device 110 and a paired device 115) that together form a single use case called a profile (e.g., for communications between the device 110 and the paired device 115). One example profile defined in the Bluetooth specification is the Handsfree Profile (HFP) for voice telephony, in which one device (e.g., a device 110) implements an Audio Gateway (AG) role and the other device (e.g., a paired device 115) implements a Handsfree (HF) device role. Another example is the Advanced Audio Distribution Profile (A2DP) for high-quality audio streaming, in which one device (e.g., device 110) implements an audio source device (SRC) role and another device (e.g., paired device 115) implements an audio sink device (SNK) role.

For a commercial Bluetooth-enabled device that implements one role in a profile to function properly, another device that implements the corresponding role may be present within the radio range of the first device. For example, in order for an HF device such as a Bluetooth headset to function according to the Handsfree Profile, a device implementing the AG role (e.g., a cell phone) may have to be present within radio range. Likewise, in order to stream high-quality mono or stereo audio according to the A2DP, a device implementing the SNK role (e.g., Bluetooth headphones or Bluetooth speakers) may have to be within radio range of a device implementing the SRC role (e.g., a stereo music player).

The Bluetooth specification defines a layered data transport architecture and various protocols and procedures to handle data communicated between two devices that implement a particular profile use case. For example, various logical links are available to support different application data transport constraints, with each logical link associated with a logical transport having one or more characteristics (e.g., flow control, acknowledgement mechanisms, repeat mechanisms, sequence numbering, scheduling behavior, etc.). The Bluetooth protocol stack may be split in two parts: a controller stack including the timing critical radio interface, and a host stack handling high level data. The controller stack may be generally implemented in a low cost silicon device including a Bluetooth radio and a microprocessor. The controller stack may be responsible for setting up connection links 125 such as asynchronous connection-less (ACL) links, (or ACL connections), synchronous connection orientated (SCO) links (or SCO connections), extended synchronous connection-oriented (eSCO) links (or eSCO connections), other logical transport channel links, etc.

In some examples, the controller stack may implement link management protocol (LMP) functions, low energy link layer (LELL) functions, etc. The host stack may be generally implemented as part of an operating system, or as an installable package on top of an operating system. The host stack may be responsible for logical link control and adaptation protocol (L2CAP) functions, Bluetooth network encapsulation protocol (BNEP) functions, service discovery protocol (SDP) functions, etc. In some examples, the controller stack and the host stack may communicate via a host controller interface (HCI). In other cases, (e.g., for integrated devices such as Bluetooth headsets), the host stack and controller stack may be run on the same microprocessor to reduce mass production costs. For such host-less systems, the HCI may be optional, and may be implemented as an internal software interface.

A connection link 125 may be established between two Bluetooth-enabled devices (e.g., between a device 110 and a paired device 115) and may provide for communications or services (e.g., according to some Bluetooth profile). For example, a Bluetooth connection may be an eSCO connection for voice call (e.g., which may allow for retransmission), an ACL connection for music streaming (e.g., A2DP), etc. For example, eSCO packets may be transmitted in determined time slots (e.g., 6 Bluetooth slots each for eSCO). The regular interval between the eSCO packets may be specified when the Bluetooth link is established. The eSCO packets to/from a specific slave device (e.g., paired device 115) are acknowledged, and may be retransmitted if not acknowledged during a retransmission window. In addition, audio may be streamed between a device 110 and a paired device 115 using an ACL connection (A2DP profile). In some examples, the ACL connection may occupy 1, 3, or 5 Bluetooth slots for data or voice. Other Bluetooth profiles supported by Bluetooth-enabled devices may include Bluetooth Low Energy (BLE) (e.g., providing considerably reduced power consumption and cost while maintaining a similar communication range), human interface device profile (HID) (e.g., providing low latency links with low power constraints), etc.

A device may, in some examples, be capable of both Bluetooth and WLAN communications. For example, WLAN and Bluetooth components may be co-located within a device, such that the device may be capable of communicating according to both Bluetooth and WLAN communication protocols, as each technology may offer different benefits or may improve user experience in different conditions. In some examples, Bluetooth and WLAN communications may share a same medium, such as the same unlicensed frequency medium. In such examples, a device 110 may support WLAN communications via AP 105 (e.g., over communication links 120). The AP 105 and the associated devices 110 may represent a basic service set (BSS) or an extended service set (ESS). The various devices 110 in the network may be able to communicate with one another through the AP 105. In some examples the AP 105 may be associated with a coverage area, which may represent a basic service area (BSA).

Devices 110 and APs 105 may communicate according to the WLAN radio and baseband protocol for physical and MAC layers from IEEE 802.11 and versions including, but not limited to, 802.11b, 802.11g 802.11a, 802.1In, 802.11ac, 802.11ad, 802.11ah, 802.11ax, etc. In other implementations, peer-to-peer connections or ad hoc networks may be implemented within wireless communications system 100, and devices may communicate with each other via communication links 120 (e.g., Wi-Fi Direct connections, Wi-Fi Tunneled Direct Link Setup (TDLS) links, peer-to-peer communication links, other peer or group connections). AP 105 may be coupled to a network, such as the Internet, and may enable a device 110 to communicate via the network (or communicate with other devices 110 coupled to the AP 105). A device 110 may communicate with a network device bi-directionally. For example, in a WLAN, a device 110 may communicate with an associated AP 105 via downlink (e.g., the communication link from the AP 105 to the device 110) and uplink (e.g., the communication link from the device 110 to the AP 105).

In some examples, content, media, audio, etc. exchanged between a device 110 and a paired device 115 may originate from a WLAN. For example, in some examples, device 110 may receive audio from an AP 105 (e.g., via WLAN communications), and the device 110 may then relay or pass the audio to the paired device 115 (e.g., via Bluetooth communications). In some examples, some types of Bluetooth communications (e.g., such as high quality or high definition (HD) Bluetooth) may include the use of enhanced quality of service. For example, in some examples, delay-sensitive Bluetooth traffic may have higher priority than WLAN traffic.

In some examples, information of an input signal (e.g., speech, music, etc.) may be filtered and separated across frequency ranges into a number of subbands. In some examples, the number of subbands may be encoded with a number of bits based on the filtering and may be transmitted in a number of packets. In some examples, the number of subbands may equal the number of packets (e.g., there may be a 1:1 relationship between the number of subbands and the number of packets). For example, each filtered subband of the input signal may be transmitted in an individual packet. As such, each packet may include information corresponding to a filtered subband and may be shorter in length and less susceptible to poor link conditions than an input signal transmitted in a single long packet. That is, transmitting each filtered subband in an individual packet may result in the input signal being communicated in a number of shorter packets, rather transmitting a single packet corresponding to all filtered subbands of the input signal.

Additionally, encoding each subband into individual packets may provide for more efficient information (e.g., subband) prioritization within wireless communications systems (e.g., wireless communications system 100). For example, transmitting devices and receiving devices (e.g., devices 110 and paired devices 115) may provide more transmission opportunities, reception opportunities, retransmission opportunities, etc. for a packet that includes higher priority information to the receiver (e.g., the user) than a packet that includes lower priority information. In some examples, lower priority information (e.g., packets corresponding to lower priority subbands, such as filtered frequency regions that are outside of an audible range) may be transmitted less frequently or may not be transmitted at all. In some examples, the distribution of how many opportunities (e.g., time slots, time-frequency resources, etc.) are provided for various subbands may be determined or set based on link conditions. For example, as link conditions deteriorate, higher priority information may be provided more opportunities, lower priority information may be provided fewer opportunities or may be dropped, etc.

In some examples, wireless communications system 100 (e.g., communicating devices 110 and paired devices 115) may prioritize a packet based on the priority of the subband of the input signal included in the packet. For example, wireless communications system 100 may prioritize a subband based on the information (e.g., the priority of the information) corresponding to the subband. In some examples, the priority of the information corresponding to a subband may be based on how the input signal is filtered and the frequency location of the input signal that is filtered into the subband.

For example, high priority subbands (e.g., and thus high priority packets) may correspond to where the most valuable information (e.g., the most relevant information for a user or a particular application) is found in the input signal. The frequency location of the signal where the most valuable information is found may depend on a tone of a speaker, a type of signal, a receiver (e.g., user) preference, an audible range, a user preference, a link condition, etc.

The priority of the information corresponding to the various filtered subbands may be preset by wireless communications system 100, determined by devices 110, paired devices 115, etc. based on an analysis of an input signal. For example, packet prioritization (priority of various packets of an input signal, with each packet encoded with information corresponding to a filtered subband) may be determined or set by wireless communications system 100 based on an analysis of a signal to be communicated between devices, an analysis of signals communicated via a codec, an analysis of signals communicated for a particular application (e.g., such as voice, HD audio), etc. Further, packet prioritization may depend on how the input signal is filtered (e.g., based on filters or filter configurations used, based on how many subbands the input signal is filtered into, based on the size or range of each filtered subband, etc.).

In some examples, the priority of a packet may be preset between communicating devices (e.g., by wireless communications system 100, by an application or codec, etc.). For example, the human ear may be more sensitive to lower end frequencies, such that, in some examples, packets corresponding to filtered subbands representing lower frequency regions of the audible frequency spectrum band may prioritized. In other words, a signal may be filtered into subbands and the filtered subbands corresponding to specific frequency regions (e.g., low frequency regions of the audible frequency spectrum band) may include higher priority information (e.g., more valuable information). Such higher priority subbands may each be encoded into individual packets that may be prioritized higher than other packets (e.g., than other packets corresponding to subbands filtered to include higher frequency ranges). In such an example, wireless communications system 100 (e.g., devices 110 and paired devices 115) may thus prioritize packets corresponding to encoded subbands filtered to include lower frequency ranges over packets corresponding to encoded subbands filtered to include higher frequency ranges.

In some examples, packet prioritization may be determined based on an analysis of a signal. For example, devices 110 or paired devices 115 (or both) may prioritize packets based on an analysis of the signal that may identify the frequency ranges that represent the higher priority information (e.g., most valuable information). The communicating devices may then prioritize packets corresponding to subbands filtered to include frequency ranges representing (e.g., conveying, including, etc.) the highest priority information. Additionally or alternatively, the devices 110 or paired devices 115 (or both) may dynamically prioritize packets based on link conditions. For example, a packet (e.g., a low priority packet) may be deprioritized to a lower prioritization level (e.g., when link conditions are poor) and may subsequently be prioritized to a higher prioritization level (e.g., when link conditions improve). In such an example, a prioritization level may refer to how packets encoded with a filtered subband are prioritized relative to other packets, the rate or interval with which packets encoded with a filtered subband are communicated, the number, frequency, and timing of opportunities associated with packets encoded with a filtered subband, etc.

According to the techniques described herein, more opportunities (e.g., transmission opportunities, reception opportunities, retransmission opportunities, etc.) may be provided for higher priority packets than lower priority packets. As such, by filtering a signal into a number of subbands, encoding each subband into an individual packet, and prioritizing packets based on the priority of the information encoded into each packet, the most important information may have a greater chance for successful reception (e.g., as high priority packets of the signal may be shorter in length and less prone to interference, as high priority packets of the signal may be allocated more opportunities, as high priority packets of the signal may be communicated earlier or more frequently than lower priority packets, etc.). The techniques described herein may provide wireless communications systems with more flexibility in the configuration of opportunities for packets associated with various priority. For example, a receiving device (e.g., a receiving device in a power saving mode) may provide reception opportunities for a first subset of packets representing a signal (e.g., a first subset of packets corresponding to higher priority subbands) and may not provide reception opportunities for a different subset of packets (e.g., a second subset packets corresponding to lower priority subbands).

The described techniques may provide various improvements to wireless communications systems. For example, more successful communications may be realized under poor link conditions (e.g., some information may be dropped or deprioritized such that higher priority information of a signal may be communicated earlier, more frequently, with more retransmission opportunities, etc., as described herein). Further, power consumption, processor utilization, and memory usage of the devices 110 and paired devices 115 may be reduced. Furthermore, the techniques described herein may provide enhancements to the operation of devices 110 and paired devices 115. The techniques described herein may provide transmission and reception efficiency to devices 110 and paired devices 115 by reducing latency associated with processes related to signal transmission. The techniques described herein may more efficiently filter, encode, and communicate high priority information of a signal for more robustness under poor link conditions, which may result in reduced latency, power consumption, and overhead (e.g., as communication latency, device power consumption, and system overhead arising from retransmissions may be reduced).

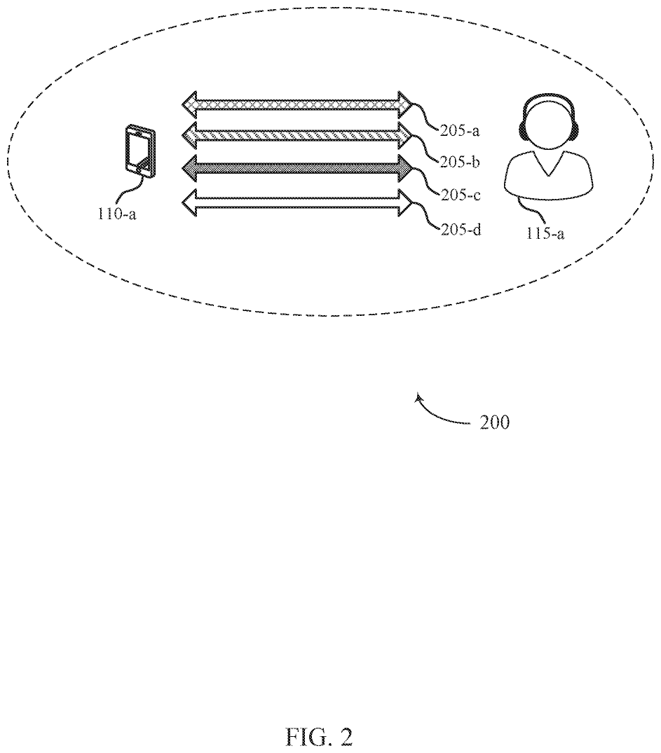

FIG. 2 illustrates an example of a wireless communications system 200 that supports transmitting and receiving individual subbands in accordance with aspects of the present disclosure. In some examples, wireless communications system 200 may implement aspects of wireless communications system 100. Device 110-a and paired device 115-a may be examples devices capable of Bluetooth communications, and each of device 110-a and paired device 115-a may be an example of a transmitting device, a receiving device, or both. For example, device 110-a and paired device 115-a may each be receiving devices at some points in time and transmitting devices at others. In some examples of the present disclosure, device 110-a may be a transmitting device and paired device 115-a may be a receiving device.

A transmitting device (e.g., device 110-a, paired device 115-a) may break down an input signal (e.g., speech, music, etc.) into a number of subbands via a series of filters, decimators, and encoders. For example, the transmitting device (e.g., a device 110-a) may process an input signal using a series of low and high pass filters or band-pass filters that separate information across the frequency band of the input signal into a number of subbands. As such, each subband may correspond to a filtered frequency range of the input signal.

The encoders of the device 110-a may allocate a number of bits to each of the filtered subbands. In some examples, the number of bits used to encode a subband may be associated with a priority of the subband. For example, the device 110-a may prioritize a first subband over a second subband and may allocate a greater number of bits to encode the first subband than to encode the second subband based on the respective priorities. In some examples, the number of bits for encoding the first subband and the second subband may be proportionate to the relative priority of the first subband and the second subband. In some examples, the device 110-a may prioritize a filtered subband based on the frequency range corresponding to the filtered subband (e.g., based on the information corresponding to the frequency range of the filtered subband).

In some examples, the device 110-a may identify a frequency range priority and prioritize subbands according to the frequency range priority. For example, a first subband may be prioritized over a second subband based on the frequency ranges corresponding to each of the first and second subband. Frequency ranges (e.g., and thus filtered subbands) of an input signal may be prioritized based on the type of input signal, the amount of information (e.g., the amount of valuable information) corresponding to various frequency range, or both. For example, a type of signal (e.g., speech) may be associated with key frequency ranges (e.g., low frequency ranges) where most of the valuable information may be located (e.g., and filtered subbands corresponding to key frequency ranges may be prioritized, packets encoded with information bits representing the key subbands may be prioritized, etc.).

In some communications systems, after encoding individual subbands (e.g., after an encoder), the output of the individual encoders may be grouped (e.g., the output of the individual encoders may be multiplexed) and transmitted in a single packet over the air by the device 110-a. In some examples, the packet may include additional codec frames. The packet may be received by a receiving device (e.g., a paired device 115-a), which may follow a similar process in the reverse order for each codec frame. In some examples, the paired device 115-a may not receive the packet correctly and may ask for (e.g., request) retransmission (e.g., if in a connected use case) or wait for the device 110-a to retransmit the packet (e.g., if in a broadcast use case). The inclusion of all subbands in a single packet makes the packet relatively long and prone to interference (e.g., from other wireless technologies), which may result in transmission failures, retransmission failures, retransmission latency, degraded user experience, etc. In some examples, the packet may be transmitted several times before it is received correctly by the paired device 115-a.

As such, according to the techniques described herein, device 110-a and paired device 115-a may filter an input signal into a number of subbands, encode each subband into an individual packet, and prioritize packets 205 based on the priority of the information encoded into each packet. Thus, instead of transmitting all of the encoded subbands in one long packet, encoded subbands may be transmitted individually in shorter packets. In some examples, the number of subbands may equal the number of packets (e.g., there may be a 1:1 relationship between the number of subbands and the number of packets). In the example of FIG. 2, input signals (e.g., signals to be wirelessly communicated between device 110-a and paired device 115-a) may be filtered into four subbands and each subband may be encoded into individual packets 205-a. For example, a first subband may be encoded into packets 205-a, a second subband may be encoded into packets 205-b, a third subband may be encoded into packets 205-c, and a fourth subband may be encoded into packets 205-d.

The device 110-a may prioritize packets 205 as discussed herein. In some examples, the priority of packets 205 may be based on the priority of the subband associated with packet 205. For example, subbands encoded into higher priority packets 205-a may be of higher priority than subbands encoded into lower priority packets 205-d.

As such, wireless communications system 200 may prioritize packets 205-a over packets 205-d based on the frequency range of the filtered subbands encoded into packets 205-a. For example, device 110-a and paired device 115-a may prioritize packets 205-a based on the information and frequency range represented by packets 205-a for various input signals.

In some examples, the packet prioritization may be dynamic (e.g., may change for different input signals, may vary with varying link conditions, etc.). For example, the prioritization level of packets 205-a, packets 205-b, packets 205-c, and packets 205-d may be statically configured (e.g., by wireless communications system 200 based on an application, codec, etc.), may be dynamically configured (e.g., by wireless communications system 200 based on an varying link conditions, varying applications, etc.), may be dynamically determined by device 110-a and paired device 115-a (e.g., based on varying link conditions, varying applications, etc.), etc.

In some examples, device 110-a may dynamically prioritize packets 205 based on a determined link condition or network condition. For example, the device 110-a may deprioritize packets 205-d to a lower prioritization level (e.g., when network conditions are poor), may prioritize packets 205-d to a higher prioritization level (e.g., when network conditions improve), etc. In some examples of the present example, the device 110-a may determine that a link condition (e.g., a throughput metric, an interference metric, a packet error rate, receiver sensitivity metric, available transmitter power margin, etc.) is above or below a threshold and prioritize packets 205-a, packets 205-b, packets 205-c, and packets 205-d accordingly.

For example, the device 110-a may deprioritize one or more of packets 205-a, packets 205-b, packets 205-c, and packets 205-d when a link condition is below the threshold, device 110-a may prioritize one or more of packets 205-a, packets 205-b, packets 205-c, and packets 205-d when the link condition exceeds the threshold, etc. In some examples, device 110-a may monitor communication with paired device 115-a and may receive an indication of the priorities of paired device 115-a and accordingly set its priorities to be consistent with the priorities of paired device 15-a (e.g., paired device 15-a may indicate subband or frequency range priorities to device 110-a, and packets 205-a, packets 205-b, packets 205-c, and packets 205-d may be prioritized accordingly).

Packets with a higher priority may be transmitted first, may have more opportunities, or both, than packets with a lower priority. For example, in cases where packets 205-a are prioritized higher than packets 205-d, packets 205-a may be transmitted first, may have more opportunities, etc. In some examples, if a link condition satisfies a threshold (e.g., under poor link conditions), packets 205-d may be dropped entirely. In some examples, if a link condition satisfies a threshold (e.g., under poor link conditions), opportunities associated with packets 205-d may be reallocated or may be used instead for packets 205-a.

The individual packets may be transmitted in individual periodic events by the device 110-a (e.g., the individual packets may be transmitted on a periodic basis) and the periodic events for the individual packets may hop around in frequency (e.g., packets belonging to the same codec frame may be transmitted using different frequencies). In some examples, the packets may be transmitted using a frequency hopping pattern. For example, packets 205-a may be associated with some frequency hopping pattern. The paired device 115-a may know the location and periodicity of these events and may be aware of which packets it may expect to receive at any given point in time. Device 110-a and paired device 115-a may communicate via a dedicated communication channel, a broadcast message, a dynamic communication method, or any other suitable method.

As discussed herein, the described techniques may provide wireless communications system 200 with more flexibility in the configuration of such events for packets associated with various priority. Generally, packets encoded with information of higher priority subbands (e.g., packets 205-a) may be allocated more transmission events or more opportunities (e.g., transmission opportunities, reception opportunities, retransmission opportunities, etc.) and packets encoded with information of lower priority subbands (e.g., packets 205-d) may be dropped or allocated fewer opportunities as link conditions deteriorate. Further, packets encoded with information of lower priority subbands may be communicated or allocated some opportunities as link conditions improve. Device 110-a and paired device 115-a may know the location and periodicity of these events or opportunities and may be aware of which packets are communicated during such events or opportunities.

Paired device 115-a may receive the individual packets and may combine the individual packets as or when the packets are successfully received (or both). For example, after receiving packets 205-a, packets 205-b, packets 205-c, and/or packets 205-d, paired device 115-a may decode the subbands included in each of packets 205-a, packets 205-b, packets 205-c, and/or packets 205-d, and paired device 115-a may combine the decoded subbands to process a single signal (e.g., the input signal transmitted by device 110-a via packets 205-a, packets 205-b, packets 205-c, and/or packets 205-d).

In some examples, paired device 115-a may combine all of packets 205-a, packets 205-b, packets 205-c, and packets 205-d associated with the signal. In other cases, paired device 115-a may only combine a subset of packets 205-a, packets 205-b, packets 205-c, and packets 205-d associated with the signal (e.g., paired device 115-a may only combine packets 205-a and packets 205-b). For example, paired device 115-a may only combine the packets that it successfully receives from device 110-a. For example, paired device 115-a may only successfully receive packets 205-a and 205-b (e.g., which may be associated with a greater number of transmission or reception opportunities (or both)).

In some examples, paired device 115-a may combine packets based on a determined link condition (e.g., which may indicative of network conditions to paired device 115-a). For example, paired device 115-a may combine all of packets 205-a, packets 205-b, packets 205-c, and packets 205-d associated with a signal (e.g., when network conditions are good) or only combine a subset of the packets (e.g., when network conditions are poor) based on the link condition. This may enable paired device 115-a to begin decoding and combining subbands without waiting until a packet associated with infrequent transmission or reception opportunities is successfully received (or both).

In some examples, paired device 115-a may decode and combine a subset of the number of packets associated with the signal based on the priority of the packets, a device preference, a user preference, etc. For example, paired device 115-a may determine to combine packets 205-a and 205-b (e.g., higher priority packets) and may determine not to combine packets 205-c and 205-d (e.g., lower priority packets). In other words, wireless communications system 200 (e.g., device 110-a) may prioritize packets 205-a and 205-b and may drop packets 205-c and packets 205-d, such that paired device 115-a may determine to combine packets 205-a and 205-b accordingly.

As discussed herein, wireless communications system 200 (e.g., device 110-a and paired device 115-a) may prioritize packets 205-a, packets 205-b, packets 205-c, and packets 205-d based on the priority of a subband corresponding to each of packets 205-a, packets 205-b, packets 205-c, and packets 205-d. For example, higher priority packets 205-a may include a higher priority subband than packets 205-d (e.g., a high priority subband may be encoded into packets 205-a). Paired device 115-a may then determine a number of reception attempts or a rate (e.g., periodicity) of reception attempts based on the prioritization level of packets 205-a.

For example, paired device 115-a may provide packets 205-a more reception opportunities than packets 205-d. In some examples, paired device 115-a (e.g., a low complexity) may determine not to provide any reception opportunities to low priority packets (e.g., low priority packets 205-d). For example, a low complexity paired device 115-a (e.g., paired device 115-a for a listener with partial hearing loss) may determine not to provide any opportunities or resources for reception of packets 205-c and 205-d (e.g., in order to save power, in order to provide more opportunities or resources for reception of packets 205-a and 205-b, etc.).

In some examples, the packet prioritization by paired device 115-a may be dynamic. For example, paired device 115-a may dynamically prioritize packets based on determined link conditions. Paired device 115-a may dynamically deprioritize one or more packets to a lower prioritization level (e.g., if network conditions are poor) and may subsequently prioritize the same one or more packets to a higher prioritization level (e.g., when network conditions improve).

In some examples, paired device 115-a may determine that the link condition is above or below a threshold and prioritize packets 205-a, packets 205-b, packets 205-c, and packets 205-d accordingly. For instance, paired device 115-a may deprioritize one or more packets when the link condition is below the threshold and prioritize the same one or more packets when the link condition exceeds the threshold. During poor link conditions, lower priority packets may not be received due to their infrequent transmission and reception opportunities. In such cases, the lack of communication of the lower priority packets may not have much perceivable effect on the user due to the lower priority of the information contained in the packets.

Generally packets may be prioritized according to one or more of various considerations. For example, packets may be prioritized in a manner to enable device 110-a or paired device 115-a (or both) to use its central processing unit (CPU) cycles for other functions. Packets may be prioritized based on the frequency range corresponding to the subband included in the various packets. For example, an individual packet may include information across a specific frequency range and packets may be prioritized based on the frequency range included in the packet.

Packets may be prioritized based on an audio quality control operation. For example, packets may be dynamically prioritized to gradually degrade audio quality until communications are optimized forgiven link conditions. In some examples, according to the audio quality control operation, device 110-a or paired device 115-a (or both) may increasingly deprioritize one or more packets gradually (e.g., for an improved user experience). Additionally, device 110-a or paired device 115-a (or both) may determine when to use the audio quality control operation. For example, device 110-a or paired device 115-a (or both) may use the audio quality control operation in the presence of varying radio frequency (RF) bandwidth limitations (e.g., RF bandwidth limitations caused by interference or other radio traffic) or in the presence of varying network conditions. This may enable a more graceful and progressive change in audio quality. Additionally or alternatively, in some examples, paired device 115-a may inform the device 110-a of its priorities and the device 110-a may set packet priority to be consistent with the priorities of paired device 115-a.

In some examples of the present disclosure, that the device 110-a or paired device 115-a (or both) may dynamically analyze a signal and prioritize the individual packets based in part on the signal. For example, the device 110-a or paired device 115-a (or both) may dynamically analyze the signal and determine which subbands are the most important (e.g., contain the most valuable information). The device 110-a or paired device 115-a (or both) may subsequently prioritize packets based on the determination. For example, the device 110-a or paired device 115-a (or both) may prioritize packets including subbands corresponding to more valuable information relative to packets including subbands corresponding to less valuable information.

The device 110-a or paired device 115-a (or both) may determine which subbands comprise more information based on the frequency range corresponding to the filtered subband. In some examples, the device 110-a or paired device 115-a (or both) may determine that one or more frequency ranges convey more valuable information (e.g., more important information) based on the type of signal. For example, a type of signal may be associated with some key frequency ranges (e.g., frequency ranges comprising most of the signal's information). For a speech signal, for example, the device 110-a or paired device 115-a (or both) may detect the tone of the speaker and may determine the frequency ranges of the signal convey the more valuable information (e.g., based on the tone of the speaker), and may prioritize the packets corresponding to the filtered subbands comprising those frequency ranges.

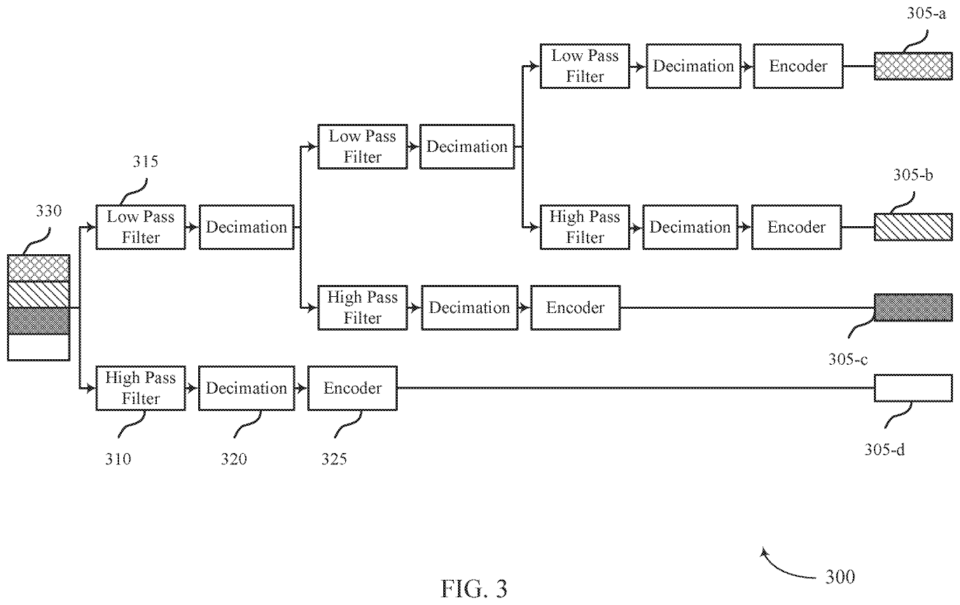

FIG. 3 illustrates an example of an encoding diagram 300 that supports transmitting and receiving individual subbands in accordance with aspects of the present disclosure. In some examples, encoding diagram 300 may implement aspects of wireless communications system 100 or wireless communications system 200 (or both). Encoding diagram 300 includes an input signal 330, a number of high pass filters 310, a number of low pass filters 315, a number of decimation filters 320, and a number of encoders 325. In some examples, high pass filters 310 and low pass filters 315 may be examples of band-pass filters. Encoding diagram 300 may illustrate an input signal 330 being broken down (e.g., processed) into a number of subbands 305 by a processor or a transmitting device (e.g., such as a device 110 or a paired device 115). For example, a transmitting device may process an input signal 330 according to encoding diagram 300, where the input signal 330 may be filtered into subband 305-a, subband 305-b, subband 305-c, and subband 305-d, and each of subband 305-a, subband 305-b, subband 305-c, and subband 305-d may encoded into individual packets (e.g., subband 305-a may be encoded into packets 205-a, subband 305-b may be encoded into packets 205-b, subband 305-c may be encoded into packets 205-c, and subband 305-d may be encoded into packets 205-d).

Input signal 330 may be broken down (e.g., filtered) into a number of subbands 305 by a transmitting device (e.g., a device 110 or a paired device 115 (or both)). A transmitting device may break down the input signal 330 into the number of subbands 305 via a number of high pass filters 310, low pass filters 315, and decimation filters 320. More specifically, encoding diagram 300 may separate (e.g., filter) information across the frequency band of the input signal 330 into a number of subbands 305. Each subband 305 may thus correspond to a filtered frequency region of the input signal 330. A transmitting device may subsequently encode each subband 305 into individual packs via encoders 325.

In the example of FIG. 3, encoding diagram 300 may illustrate filtering input signal 330 into four subbands (e.g., subbands 305-a. 305-b, 305-c, and 305-d). The frequency range corresponding to each subband 305 may be determined based on the sequence of high pass filters 310, low pass filters 315, and decimation filters 320 each subband 305 is passed through. For example, subband 305-a may be filtered as a result of a series of low pass filters 315 (e.g., three low pass filters 315), such that subband 305-a may comprise the lowest frequency range of input signal 330. Subband 305-d may be filtered as a result of a series of high pass filters 310 (e.g., a single high pass filter 310), such that subband 305-d may comprise the highest frequency range of input signal 330.

Encoding diagram 300 may separate input signal 330 into a number of other subbands comprising frequencies between subband 305-a and subband 305-d. For example, subbands 305-b and 305-c may be filtered as a result of a mixed series of low pass filters 315 and high pass filters 310. In one example herein, subband 305-b may be filtered as a result of two low pass filters 315 and one high pass filter 310 and may correspond to a frequency range adjacent to the frequency range comprised by subband 305-a. In another example herein, subband 305-c may be filtered as a result of one low pass filter 315 and one high pass filter 310 and may correspond to a frequency range between the frequency ranges corresponding to subbands 305-b and 305-d.

In some examples, each pair of low pass filter 315 and high pass filter 310 may split the frequency spectrum of an input signal in half. For example, at the first pair of low pass filter 315 and high pass filter 310, input signal 330 may be split in half, with the upper half of the frequency spectrum of input signal 330 becoming subband 305-d and the lower half continuing through encoding diagram 300. In this example, subband 305-a may comprise the lowest 12.5% of the frequency spectrum of input signal 330, subband 305-b may comprise the next lowest 12.5%, subband 305-c may comprise the next lowest 25%, and subband 305-d may comprise the highest 50%. In some examples, input signal 330 may be broken down into a number of subbands 305 (e.g., four) using band-pass filters.

At the encoder 325, a transmitting device may allocate a number of bits to each subband 305. In some examples, a subband 305 may be encoded based on the frequency region of the input signal 330 corresponding to the subband 305 (e.g., a subband may be encoded into a packet using a number of bits corresponding to the priority of the subband). For example, subband 305-a may comprise a first frequency band (e.g., a frequency band associated with higher priority information) and may be encoded with a greater number of bits than subband 305-d comprising a second frequency band (e.g., a frequency band associated with lower priority information). In some examples, the number of bits used to encode a subband 305 may be associated with a priority of the subband 305. For example, a transmitting device may prioritize subband 305-a over subband 305-d and may allocate a proportionally greater number of bits used to encode subband 305-a into a high priority packet than the number of bits used to encode subband 305-d into a relatively lower priority packet, based on the respective priorities of subband 305-a and 305-d.

In some examples, a device 110 or a paired device 115 (or both) may identify a frequency range priority and prioritize subbands 305 according to the frequency range priority. For example, a subband 305 may include information across a specific frequency range of the input signal 330, and device 110 or paired device 115 (or both) may prioritize the subband 305 based on the frequency range included in the subband 305. A specific frequency range of input signal 330 may be prioritized based on the type of input signal, the priority of the information corresponding to the frequency range, user preferences, link conditions, etc.

A receiving device (e.g., a device 110 or a paired device 115 (or both)) may receive the individual packets (e.g., subbands encoded into individual packets) and may combine the subbands 305 included in the packets (e.g., to process the input signal 330). For example, after receiving a number of packets, the receiving device may decode the subbands 305 included in the number of packets and the receiving device may combine the decoded subbands 305 into a single signal (e.g., to process the input signal 330). In some examples, the receiving device may combine all of the number of subbands 305 associated with the input signal 330. In other cases (e.g., when some subbands are deprioritized, dropped, etc.), the receiving device may only combine a subset of the number of subbands 305 associated with the input signal 330. The number of subbands 305 that a receiving device may combine may depend on packet prioritization (e.g., the priority of the subbands 305-a through 305-d and packets corresponding to each of the subbands 305-a through 305-d), link conditions, capabilities of the receiving device, etc.

That is, in some examples, encoding or decoding schemes (e.g., as exemplified by encoding diagram 300) or both may be implemented, in some examples, based on packet prioritization. For example, in some examples, low priority subbands may be thrown out prior to encoding such that only high priority subbands are encoded into packets for transmission. Encoding diagram 300 illustrates an example of how an input signal 330 may be filtered into subbands and how each subband may be encoded and subsequently transmitted in individual packets (e.g., without multiplexing of multiple encoded subbands into a single packet). Encoding diagram 300 is discussed for illustrative purposes and is not intended to limit the scope of the present disclosure. Various encoding or decoding schemes may be implemented (e.g. to filter an input signal 330 into any number subbands, into subbands corresponding to various frequency ranges of an input signal 330, etc., where the subbands are encoded into individual packets) by analogy, without departing from the scope of the present disclosure.

As discussed herein, transmitting all or a portion of an input signal 330 in individual subband 305 based packets may enable wireless communications systems (e.g., communicating devices) to have more flexibility in prioritizing and scheduling information. For example, packets corresponding to subband 305-a (e.g., packets 205-a) may be associated (e.g., configured) with more opportunities than packets corresponding to subband 305-d (e.g., packets 205-d). As such, higher priority information may be more communicated more robustly and successfully under poor link conditions resulting in improved communications (e.g., for low latency applications, for reliable communication applications, etc.).

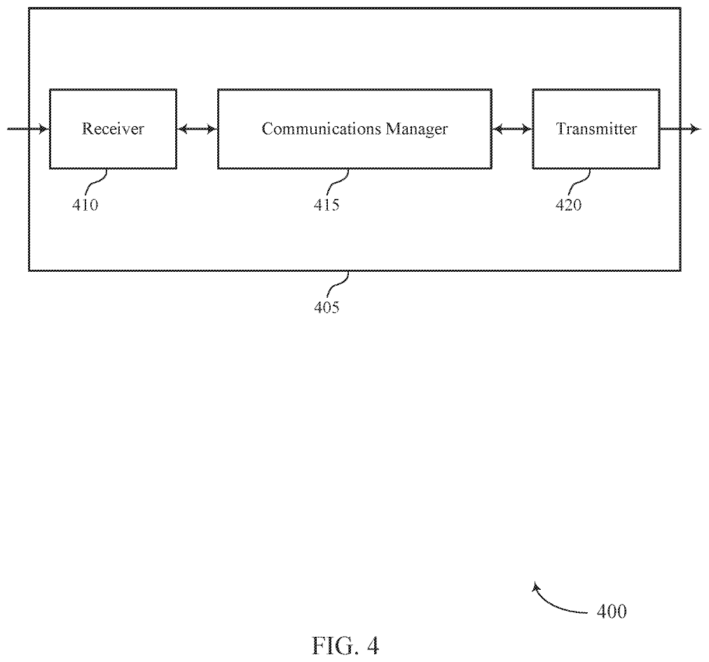

FIG. 4 shows a block diagram 400 of a device 405 that supports transmitting and receiving individual subbands in accordance with aspects of the present disclosure. The device 405 may be an example of aspects of a device 110 or a paired device 115 or any combination thereof as described herein. The device 405 may include a receiver 410, a communications manager 415, and a transmitter 420. The device 405 may also include a processor. Each of these components may be in communication with one another (e.g., via one or more buses).

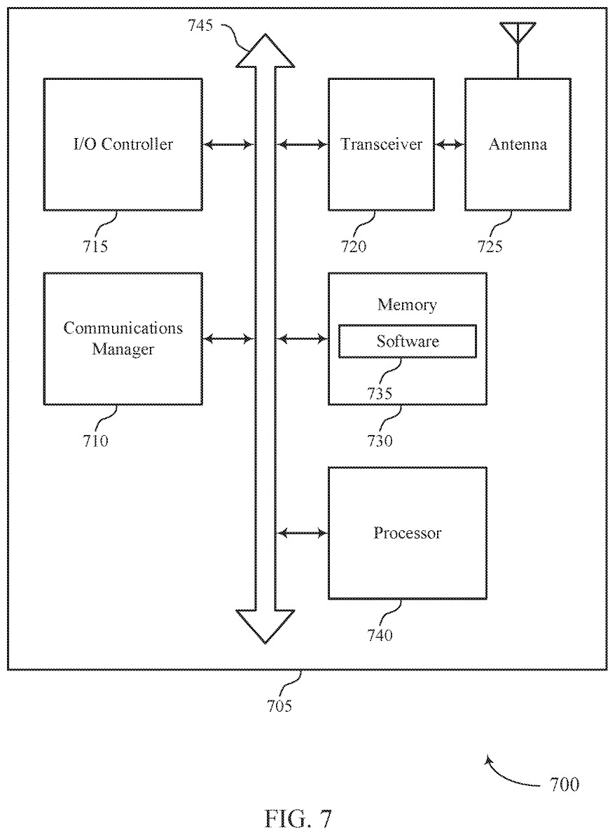

The receiver 410 may receive information such as packets, user data, or control information associated with various information channels (e.g., control channels, data channels, and information related to transmitting and receiving individual subbands, etc.). Information may be passed on to other components of the device 405. The receiver 410 may be an example of aspects of the transceiver 720 described with reference to FIG. 7. The receiver 410 may utilize a single antenna or a set of antennas.

The communications manager 415 may encode a set of subbands corresponding to an input signal into a set of packets, each packet of the set of packets including encoded data corresponding to a single respective subband, determine that a first priority of a first subband encoded in a first packet of the set of packets is different than a second priority of a second subband encoded in a second packet of the set of packets, determine a link condition that includes a link quality condition, a type of traffic associated with the link, or both, and transmit the first packet in a first transmission occasion based on the determined link condition and the determination that the first priority is different than the second priority. The communications manager 415 may also determine that a first priority of a first subband is higher than a second priority of a second subband, receive one or more packets corresponding to a set of subbands, where each packet of the one or more packets includes encoded data corresponding to a single respective subband, and decode a first packet corresponding to the first subband having the higher priority based on the determination that the first priority is higher than the second priority. The communications manager 415 may be an example of aspects of the communications manager 710 described herein.

The communications manager 415, or its sub-components, may be implemented in hardware, code (e.g., software or firmware) executed by a processor, or any combination thereof. If implemented in code executed by a processor, the functions of the communications manager 415, or its sub-components may be executed by a general-purpose processor, a DSP, an application-specific integrated circuit (ASIC), a FPGA or other programmable logic device, discrete gate or transistor logic, discrete hardware components, or any combination thereof designed to perform the functions described in the present disclosure.

The communications manager 415, or its sub-components, may be physically located at various positions, including being distributed such that portions of functions are implemented at different physical locations by one or more physical components. In some examples, the communications manager 415, or its sub-components, may be a separate and distinct component in accordance with various aspects of the present disclosure. In some examples, the communications manager 415, or its sub-components, may be combined with one or more other hardware components, including but not limited to an input/output (I/O) component, a transceiver, a network server, another computing device, one or more other components described in the present disclosure, or a combination thereof in accordance with various aspects of the present disclosure.

The transmitter 420 may transmit signals generated by other components of the device 405. In some examples, the transmitter 420 may be collocated with a receiver 410 in a transceiver component. For example, the transmitter 420 may be an example of aspects of the transceiver 720 described with reference to FIG. 7. The transmitter 420 may utilize a single antenna or a set of antennas.

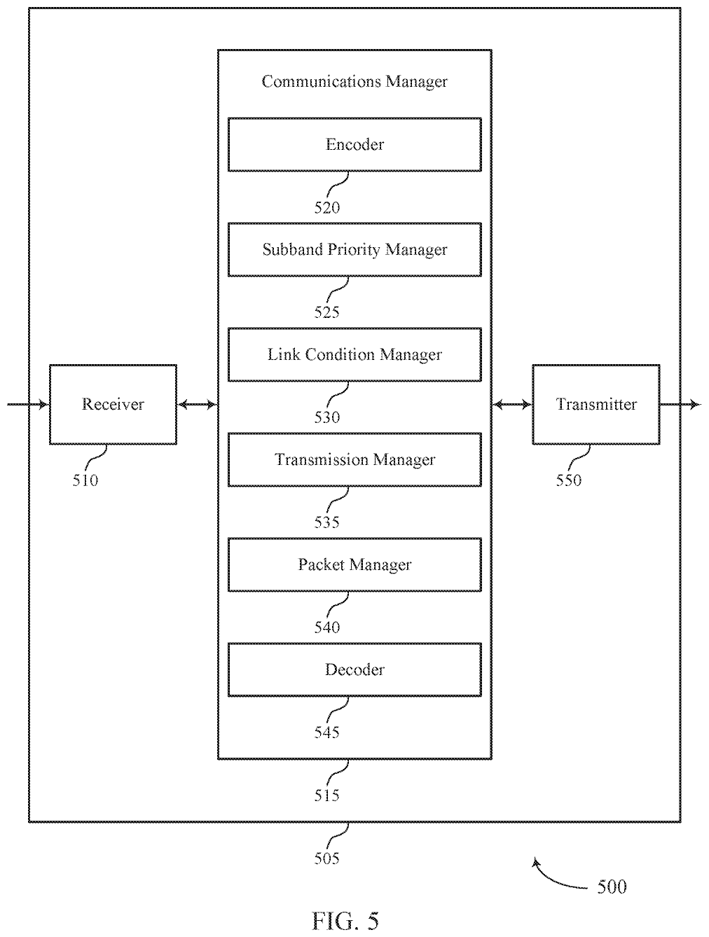

FIG. 5 shows a block diagram 500 of a device 505 that supports transmitting and receiving individual subbands in accordance with aspects of the present disclosure. The device 505 may be an example of aspects of a device 405, a device 110, or a paired device 115 or any combination thereof as described herein. The device 505 may include a receiver 510, a communications manager 515, and a transmitter 550. The device 505 may also include a processor. Each of these components may be in communication with one another (e.g., via one or more buses).

The receiver 510 may receive information such as packets, user data, or control information associated with various information channels (e.g., control channels, data channels, and information related to transmitting and receiving individual subbands, etc.). Information may be passed on to other components of the device 505. The receiver 510 may be an example of aspects of the transceiver 720 described with reference to FIG. 7. The receiver 510 may utilize a single antenna or a set of antennas.

The communications manager 515 may be an example of aspects of the communications manager 415 as described herein. The communications manager 515 may include an encoder 520, a subband priority manager 525, a link condition manager 530, a transmission manager 535, a packet manager 540, and a decoder 545. The communications manager 515 may be an example of aspects of the communications manager 710 described herein.

The encoder 520 may encode a set of subbands corresponding to an input signal into a set of packets, each packet of the set of packets including encoded data corresponding to a single respective subband. The subband priority manager 525 may determine that a first priority of a first subband encoded in a first packet of the set of packets is different than a second priority of a second subband encoded in a second packet of the set of packets. The link condition manager 530 may determine a link condition that includes a link quality condition, a type of traffic associated with the link, or both. The transmission manager 535 may transmit the first packet in a first transmission occasion based on the determined link condition and the determination that the first priority is different than the second priority. The subband priority manager 525 may determine that a first priority of a first subband is higher than a second priority of a second subband. The packet manager 540 may receive one or more packets corresponding to a set of subbands, where each packet of the one or more packets includes encoded data corresponding to a single respective subband.

The decoder 545 may decode a first packet corresponding to the first subband having the higher priority based on the determination that the first priority is higher than the second priority.

The transmitter 550 may transmit signals generated by other components of the device 505. In some examples, the transmitter 550 may be collocated with a receiver 510 in a transceiver component. For example, the transmitter 550 may be an example of aspects of the transceiver 720 described with reference to FIG. 7. The transmitter 550 may utilize a single antenna or a set of antennas.

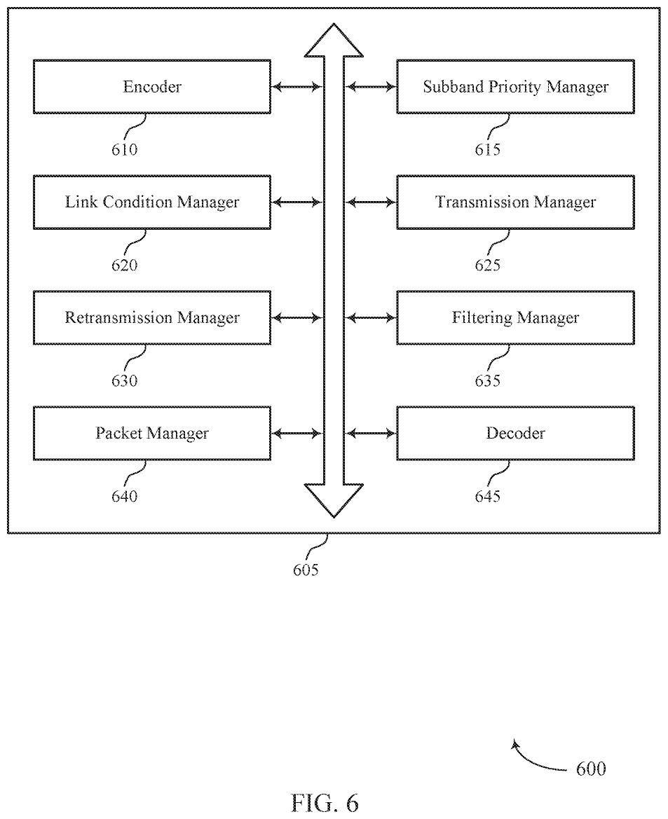

FIG. 6 shows a block diagram 600 of a communications manager 605 that supports transmitting and receiving individual subbands in accordance with aspects of the present disclosure. The communications manager 605 may be an example of aspects of a communications manager 415, a communications manager 515, or a communications manager 710 described herein. The communications manager 605 may include an encoder 610, a subband priority manager 615, a link condition manager 620, a transmission manager 625, a retransmission manager 630, a filtering manager 635, a packet manager 640, and a decoder 645. Each of these components may communicate, directly or indirectly, with one another (e.g., via one or more buses).

The encoder 610 may encode a set of subbands corresponding to an input signal into a set of packets, each packet of the set of packets including encoded data corresponding to a single respective subband.

The subband priority manager 615 may determine that a first priority of a first subband encoded in a first packet of the set of packets is different than a second priority of a second subband encoded in a second packet of the set of packets. In some examples, the subband priority manager 615 may determine that a first priority of a first subband is higher than a second priority of a second subband. In some examples, the subband priority manager 615 may transmit an indication of the first transmission occasion, the second transmission occasion, the first periodicity, the second periodicity, the first number of retransmission opportunities, the second number of retransmission opportunities, or some combination thereof, where the first packet is transmitted based on the transmitted indication.

In some examples, the subband priority manager 615 may identify a frequency range priority of one or more frequency ranges of the input signal, where the determination that the first priority of the first subband encoded in the first packet is different than the second priority of the second subband encoded in the second packet is based on the identified frequency range priority. In some examples, the subband priority manager 615 may receive an indication of a first frequency range, where the frequency range priority is identified based on the received indication. In some examples, the subband priority manager 615 may transmit an indication of the first priority of the first subband, where the one or more packets are received based on the transmitted indication.

In some examples, the first transmission occasion, a first periodicity associated with the first transmission occasion, a first number of retransmission opportunities associated with the first packet, or some combination thereof is based on the first priority, and where the second transmission occasion, a second periodicity associated with the second transmission occasion, a second number of retransmission opportunities associated with the second packet, or some combination thereof is based on the second priority. In some examples, the frequency range priority is identified based on the frequency location of the audio data in the input signal.

The link condition manager 620 may determine a link condition that includes a link quality condition, a type of traffic associated with the link, or both. In some examples, the link condition manager 620 may determine the link quality condition is below a threshold, where the retransmission opportunity associated with the first packet is identified based on the determination that the link quality condition is below the threshold.

The transmission manager 625 may transmit the first packet in a first transmission occasion based on the determined link condition and the determination that the first priority is different than the second priority. In some examples, the transmission manager 625 may transmit the second packet in a second transmission occasion based on the determined link condition and the determination that the first priority is different than the second priority, where the first transmission occasion precedes the second transmission occasion.

The packet manager 640 may receive one or more packets corresponding to a set of subbands, where each packet of the one or more packets includes encoded data corresponding to a single respective subband. In some examples, the first packet is received in a first transmission occasion preceding a second transmission occasion associated with a second packet of the one or more packets and the first packet is associated with more retransmission opportunities than the second packet.

The decoder 645 may decode a first packet corresponding to the first subband having the higher priority based on the determination that the first priority is higher than the second priority.

The retransmission manager 630 may identify a retransmission opportunity associated with the first packet. In some examples, the retransmission manager 630 may retransmit the first packet based on the retransmission opportunity, where the first packet is associated with more retransmission opportunities than the second packet.

The filtering manager 635 may filter the input signal to generate the set of subbands based on the identified frequency range priority of the one or more frequency ranges, where the set of subbands are encoded based on the filtering.

FIG. 7 shows a diagram of a system 700 including a device 705 that supports transmitting and receiving individual subbands in accordance with aspects of the present disclosure. The device 705 may be an example of or include the components of device 405, device 505, a device 110, or a paired device 115, or any combination thereof as described herein. The device 705 may include components for bi-directional voice and data communications including components for transmitting and receiving communications, including a communications manager 710, an I/O controller 715, a transceiver 720, an antenna 725, memory 730, and a processor 740. These components may be in electronic communication via one or more buses (e.g., bus 745).

The communications manager 710 may encode a set of subbands corresponding to an input signal into a set of packets, each packet of the set of packets including encoded data corresponding to a single respective subband, determine that a first priority of a first subband encoded in a first packet of the set of packets is different than a second priority of a second subband encoded in a second packet of the set of packets, determine a link condition that includes a link quality condition, a type of traffic associated with the link, or both, and transmit the first packet in a first transmission occasion based on the determined link condition and the determination that the first priority is different than the second priority. The communications manager 710 may also determine that a first priority of a first subband is higher than a second priority of a second subband, receive one or more packets corresponding to a set of subbands, where each packet of the one or more packets includes encoded data corresponding to a single respective subband, and decode a first packet corresponding to the first subband having the higher priority based on the determination that the first priority is higher than the second priority.

The I/O controller 715 may manage input and output signals for the device 705. The I/O controller 715 may also manage peripherals not integrated into the device 705. In some examples, the I/O controller 715 may represent a physical connection or port to an external peripheral. In some examples, the I/O controller 715 may utilize an operating system such as iOS®, ANDROID®, MS-DOS®, MS-WINDOWS), OS/2®, UNIX®, LINUX®, or another known operating system. In other cases, the I/O controller 715 may represent or interact with a modem, a keyboard, a mouse, a touchscreen, or a similar device. In some examples, the I/O controller 715 may be implemented as part of a processor. In some examples, a user may interact with the device 705 via the I/O controller 715 or via hardware components controlled by the I/O controller 715.

The transceiver 720 may communicate bi-directionally, via one or more antennas, wired, or wireless links as described above. For example, the transceiver 720 may represent a wireless transceiver and may communicate bi-directionally with another wireless transceiver. The transceiver 720 may also include a modem to modulate the packets and provide the modulated packets to the antennas for transmission, and to demodulate packets received from the antennas.

In some examples, the wireless device may include a single antenna 725. However, in some examples the device may have more than one antenna 725, which may be capable of concurrently transmitting or receiving multiple wireless transmissions.

The memory 730 may include RAM and ROM. The memory 730 may store computer-readable, computer-executable code or software 735 including instructions that, when executed, cause the processor to perform various functions described herein. In some examples, the memory 730 may contain, among other things, a BIOS which may control basic hardware or software operation such as the interaction with peripheral components or devices.

The processor 740 may include an intelligent hardware device, (e.g., a general-purpose processor, a DSP, a CPU, a microcontroller, an ASIC, an FPGA, a programmable logic device, a discrete gate or transistor logic component, a discrete hardware component, or any combination thereof). In some examples, the processor 740 may be configured to operate a memory array using a memory controller. In other cases, a memory controller may be integrated into the processor 740. The processor 740 may be configured to execute computer-readable instructions stored in a memory (e.g., the memory 730) to cause the device 705 to perform various functions (e.g., functions or tasks supporting transmitting and receiving individual subbands).

The software 735 may include instructions to implement aspects of the present disclosure, including instructions to support wireless communications. The software 735 may be stored in a non-transitory computer-readable medium such as system memory or other type of memory. In some examples, the software 735 may not be directly executable by the processor 740 but may cause a computer (e.g., when compiled and executed) to perform functions described herein.

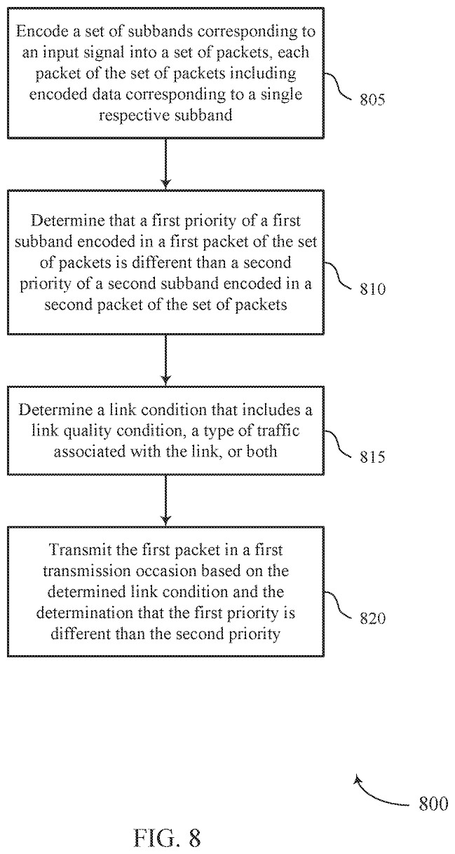

FIG. 8 shows a flowchart illustrating a method 800 that supports transmitting and receiving individual subbands in accordance with aspects of the present disclosure. The operations of method 800 may be implemented by a device or its components as described herein (or by a paired device or its components as described herein). For example, the operations of method 800 may be performed by a communications manager as described with reference to FIGS. 4 through 7. In some examples, a device may execute a set of instructions to control the functional elements of the device to perform the functions described below. Additionally or alternatively, a device may perform aspects of the functions described below using special-purpose hardware.

At 805, the device may encode a set of subbands corresponding to an input signal into a set of packets, each packet of the set of packets including encoded data corresponding to a single respective subband. The operations of 805 may be performed according to the methods described herein. In some examples, aspects of the operations of 805 may be performed by an encoder as described with reference to FIGS. 4 through 7.

At 810, the device may determine that a first priority of a first subband encoded in a first packet of the set of packets is different than a second priority of a second subband encoded in a second packet of the set of packets. The operations of 810 may be performed according to the methods described herein. In some examples, aspects of the operations of 810 may be performed by a subband priority manager as described with reference to FIGS. 4 through 7.

At 815, the device may determine a link condition that includes a link quality condition, a type of traffic associated with the link, or both. The operations of 815 may be performed according to the methods described herein. In some examples, aspects of the operations of 815 may be performed by a link condition manager as described with reference to FIGS. 4 through 7.

At 820, the device may transmit the first packet in a first transmission occasion based on the determined link condition and the determination that the first priority is different than the second priority. The operations of 820 may be performed according to the methods described herein. In some examples, aspects of the operations of 820 may be performed by a transmission manager as described with reference to FIGS. 4 through 7.

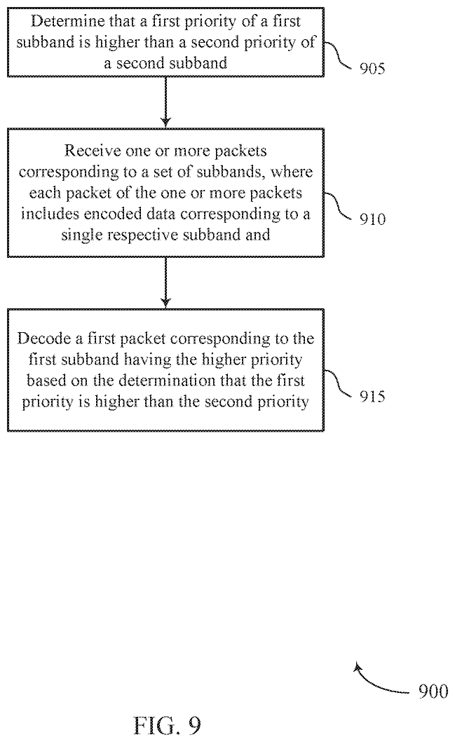

FIG. 9 shows a flowchart illustrating a method 900 that supports transmitting and receiving individual subbands in accordance with aspects of the present disclosure. The operations of method 900 may be implemented by a device or its components as described herein (or by a paired device or its components as described herein). For example, the operations of method 900 may be performed by a communications manager as described with reference to FIGS. 4 through 7. In some examples, a device may execute a set of instructions to control the functional elements of the device to perform the functions described below. Additionally or alternatively, a device may perform aspects of the functions described below using special-purpose hardware.

At 905, the device may determine that a first priority of a first subband is higher than a second priority of a second subband. The operations of 905 may be performed according to the methods described herein. In some examples, aspects of the operations of 905 may be performed by a subband priority manager as described with reference to FIGS. 4 through 7.

At 910, the device may receive one or more packets corresponding to a set of subbands, where each packet of the one or more packets includes encoded data corresponding to a single respective subband. The operations of 910 may be performed according to the methods described herein. In some examples, aspects of the operations of 910 may be performed by a packet manager as described with reference to FIGS. 4 through 7.

At 915, the device may decode a first packet corresponding to the first subband having the higher priority based on the determination that the first priority is higher than the second priority. The operations of 915 may be performed according to the methods described herein. In some examples, aspects of the operations of 915 may be performed by a decoder as described with reference to FIGS. 4 through 7.

The methods described herein describe possible implementations, and that the operations and the steps may be rearranged or otherwise modified and that other implementations are possible. Furthermore, aspects from two or more of the methods may be combined.

Techniques described herein may be used for various wireless communications systems such as code division multiple access (CDMA), time division multiple access (TDMA), frequency division multiple access (FDMA), orthogonal frequency division multiple access (OFDMA), single carrier frequency division multiple access (SC-FDMA), and other systems. The terms “system” and “network” are often used interchangeably. A code division multiple access (CDMA) system may implement a radio technology such as CDMA2000, Universal Terrestrial Radio Access (UTRA), etc. CDMA2000 covers IS-2000. IS-95, and IS-856 standards. IS-2000 Releases may be commonly referred to as CDMA2000 1×, 1×, etc. IS-856 (TIA-856) is commonly referred to as CDMA2000 1×EV-DO, High Rate Packet Data (HRPD), etc. UTRA includes Wideband CDMA (WCDMA) and other variants of CDMA. A time division multiple access (TDMA) system may implement a radio technology such as Global System for Mobile Communications (GSM). An orthogonal frequency division multiple access (OFDMA) system may implement a radio technology such as Ultra Mobile Broadband (UMB). Evolved UTRA (E-UTRA), IEEE 802.11 (Wi-Fi), IEEE 802.16 (WiMAX), IEEE 802.20, Flash-OFDM, etc.

The wireless communications system or systems described herein may support synchronous or asynchronous operation. For synchronous operation, the stations may have similar frame timing, and transmissions from different stations may be approximately aligned in time. For asynchronous operation, the stations may have different frame timing, and transmissions from different stations may not be aligned in time. The techniques described herein may be used for either synchronous or asynchronous operations.

The downlink transmissions described herein may also be called forward link transmissions while the uplink transmissions may also be called reverse link transmissions. Each communication link described herein—including, for example, wireless communications system 100 and 200 of FIGS. 1 and 2—may include one or more carriers, where each carrier may be a signal made up of multiple sub-carriers (e.g., waveform signals of different frequencies).

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims. “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, electrically erasable programmable read-only memory (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, digital subscriber line (DSL), or wireless technologies such as infrared, radio, and microwave are included in the definition of medium. Disk and disc, as used herein, include CD, laser disc optical disc, digital versatile disc (DVD), floppy disk and Blu-ray disc where disks usually reproduce data magnetically, while discs reproduce data optically with lasers. Combinations of the above are also included within the scope of computer-readable media.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

What is claimed is:

1. A method for communication at a wireless device, comprising:
encoding a plurality of subbands corresponding to an input signal into a plurality of packets, each packet of the plurality of packets comprising encoded data corresponding to a single respective subband;
determining that a first priority of a first subband encoded in a first packet of the plurality of packets is different than a second priority of a second subband encoded in a second packet of the plurality of packets;
determining a link condition that comprises a link quality condition, a type of traffic associated with the link, or both; and
transmitting the first packet in a first transmission occasion based at least in part on the determined link condition and the determination that the first priority is different than the second priority.

2. The method of claim 1, further comprising:
transmitting the second packet in a second transmission occasion based at least in part on the determined link condition and the determination that the first priority is different than the second priority, wherein the first transmission occasion precedes the second transmission occasion.

3. The method of claim 2, further comprising:
identifying a retransmission opportunity associated with the first packet; and
retransmitting the first packet based at least in part on the retransmission opportunity, wherein the first packet is associated with more retransmission opportunities than the second packet.

4. The method of claim 3, wherein determining the link condition comprises:
determining the link quality condition is below a threshold, wherein the retransmission opportunity associated with the first packet is identified based at least in part on the determination that the link quality condition is below the threshold.

5. The method of claim 3, wherein the first transmission occasion, a first periodicity associated with the first transmission occasion, a first number of retransmission opportunities associated with the first packet, or some combination thereof is based at least in part on the first priority, and wherein the second transmission occasion, a second periodicity associated with the second transmission occasion, a second number of retransmission opportunities associated with the second packet, or some combination thereof is based at least in part on the second priority.

6. The method of claim 5, further comprising:
transmitting an indication of the first transmission occasion, the second transmission occasion, the first periodicity, the second periodicity, the first number of retransmission opportunities, the second number of retransmission opportunities, or some combination thereof, wherein the first packet is transmitted based at least in part on the transmitted indication.

7. The method of claim 1, further comprising:
identifying a frequency range priority of one or more frequency ranges of the input signal, wherein the determination that the first priority of the first subband encoded in the first packet is different than the second priority of the second subband encoded in the second packet is based at least in part on the identified frequency range priority.

8. The method of claim 7, further comprising:
receiving an indication of a first frequency range, wherein the frequency range priority is identified based at least in part on the received indication.

9. The method of claim 7, identifying a frequency location of audio data in the input signal, wherein the frequency range priority is identified based at least in part on the frequency location of the audio data in the input signal.

10. The method of claim 7, further comprising:
filtering the input signal to generate the plurality of subbands based at least in part on the identified frequency range priority of the one or more frequency ranges, wherein the plurality of subbands are encoded based at least in part on the filtering.

11. A method for communication at a wireless device, comprising:
determining that a first priority of a first subband is higher than a second priority of a second subband;
receiving one or more packets corresponding to a plurality of subbands, wherein each packet of the one or more packets comprises encoded data corresponding to a single respective subband; and
decoding a first packet corresponding to the first subband having the higher priority based at least in part on the determination that the first priority is higher than the second priority.

12. The method of claim 11, further comprising:
transmitting an indication of the first priority of the first subband, wherein the one or more packets are received based at least in part on the transmitted indication.

13. The method of claim 11, wherein the first packet is received in a first transmission occasion preceding a second transmission occasion associated with a second packet of the one or more packets and the first packet is associated with more retransmission opportunities than the second packet.

14. An apparatus for communication at a wireless device, comprising:
a processor,
memory coupled with the processor; and
instructions stored in the memory and executable by the processor to cause the apparatus to:
encode a plurality of subbands corresponding to an input signal into a plurality of packets, each packet of the plurality of packets comprising encoded data corresponding to a single respective subband;
determine that a first priority of a first subband encoded in a first packet of the plurality of packets is different than a second priority of a second subband encoded in a second packet of the plurality of packets;
determine a link condition that comprises a link quality condition, a type of traffic associated with the link, or both; and
transmit the first packet in a first transmission occasion based at least in part on the determined link condition and the determination that the first priority is different than the second priority.

15. The apparatus of claim 14, wherein the instructions are further executable by the processor to cause the apparatus to:
transmit the second packet in a second transmission occasion based at least in part on the determined link condition and the determination that the first priority is different than the second priority, wherein the first transmission occasion precedes the second transmission occasion.

16. The apparatus of claim 15, wherein the instructions are further executable by the processor to cause the apparatus to:
identify a retransmission opportunity associated with the first packet; and
retransmit the first packet based at least in part on the retransmission opportunity, wherein the first packet is associated with more retransmission opportunities than the second packet.

17. The apparatus of claim 16, wherein the instructions to determine the link condition are executable by the processor to cause the apparatus to:
determine the link quality condition is below a threshold, wherein the retransmission opportunity associated with the first packet is identified based at least in part on the determination that the link quality condition is below the threshold.

18. The apparatus of claim 16, wherein the first transmission occasion, a first periodicity associated with the first transmission occasion, a first number of retransmission opportunities associated with the first packet, or some combination thereof is based at least in part on the first priority, and wherein the second transmission occasion, a second periodicity associated with the second transmission occasion, a second number of retransmission opportunities associated with the second packet, or some combination thereof is based at least in part on the second priority.

19. The apparatus of claim 18, wherein the instructions are further executable by the processor to cause the apparatus to:
transmit an indication of the first transmission occasion, the second transmission occasion, the first periodicity, the second periodicity, the first number of retransmission opportunities, the second number of retransmission opportunities, or some combination thereof, wherein the first packet is transmitted based at least in part on the transmitted indication.

20. The apparatus of claim 14, wherein the instructions are further executable by the processor to cause the apparatus to:
identify a frequency range priority of one or more frequency ranges of the input signal, wherein the determination that the first priority of the first subband encoded in the first packet is different than the second priority of the second subband encoded in the second packet is based at least in part on the identified frequency range priority.
